(19) United States
(12) Patent Application Publication
(10) Pub. No.: US 2017/0223045 A1
(43) Pub. Date: Aug. 3, 2017

(54) METHOD OF FORWARDING DATA BETWEEN COMPUTER SYSTEMS, COMPUTER NETWORK INFRASTRUCTURE AND COMPUTER PROGRAM PRODUCT

(71) Applicant: Fujitsu Technology Solutions Intellectual Property GmbH, München (DE)

(72) Inventor: Heinz-Josef Claes, Ronneburg (DE)

(21) Appl. No.: 15/315,996

(22) PCT Filed: Jun. 1, 2015
(86) PCT No.: PCT/EP2015/062160

§ 371 Date: Dec. 2, 2016

(30) Foreign Application Priority Data
Jun. 3, 2014 (DE) 10 2014 107 793.8

(51) Int. Cl. H04L 29/06; H04L 12/707; H04L 12/721

(52) U.S. Cl. CPC H04L 63/1441; H04L 45/34; H04L 45/24; H04L 63/1433; H04L 63/0428; H04L 63/06

(57) ABSTRACT

A method forwards data between secured computer systems in a computer network structure. Data packets are transmitted along a predetermined communication path structure from a source computer system to at least one target computer system by means of a group of task servers, wherein the communication path structure comprises a plurality of parallel sub-paths. Both the source computer system and the target computer system keep predetermined network ports closed such that no connection establishment from the exterior to the source computer system or to the target computer system is permitted, wherein, the source computer system or the target computer system can establish a connection to a respective broker computer system to store data packets in the broker computer system or to fetch them from there.

### TECHNICAL FIELD

This disclosure relates to a method of forwarding data between secured computer systems in a computer network infrastructure, a corresponding computer network infrastructure as well as a computer program product configured, when executed, to perform a corresponding method.

### BACKGROUND

Distributed computer networks and so-called computer network infrastructures, respectively, describe a multitude of computer systems that can communicate with each other via data connections. Confidential content is exchanged to some extent to which non-authorized persons shall not have any access possibility. In particular in computer network infrastructures that include server-client-topologies, confidential data, e.g. customer data or user data, is exchanged between client and server, wherein third party access to the data has to be suppressed.

Conventional security strategies to increase the data protection include provisions (processes to be respected) or regulations (rules or prohibitions) for third parties such as administrators, whereby only a restricted or controlled access shall be allowed to confidential data.

On the other hand, technical measures are provided to or in the computer systems to prevent physical and/or logical access to computer systems and limit access only to authorized persons, respectively.

However, such approaches to improving the data protection promote data security, but come with the disadvantage that they usually do not constitute obligatory measures to prevent access to confidential data.

Furthermore, for the data exchange or communication among one another, common computer network infrastructures work with access possibilities, for example, via network, or possibilities of addressability of services within the computer systems that make them vulnerable to external attacks. This is because, for services to be addressable, a running program is required on one or multiple network ports of a computer system. This running program constitutes a potential security gap for external attacks via network.

There is thus a risk that possibly an attacker (hacker) who gains access to a computer system may tap confidential data on the computer system and/or gains access to further computer systems in the computer network infrastructure through the attack, e.g. because the attacker is disguised to be trustworthy by a manipulated signature.

On the other hand, in conventional computer network infrastructures, in particular in the IT service sector, there is an effort to configure a high-availability computer network in which the general functions of the infrastructure are to be maintained despite the failure of individual computer systems or network connections between computer systems. To that end, data is redundantly transmitted or distributed in the computer network infrastructure to be able to be processed at another place and possibly enable a recovery of predetermined states (disaster recovery) if individual entities fail.

However, the last measures may be problematic against the background of data security or access of non-authorized persons to high-availability distributed data within the computer network infrastructure because security-relevant or confidential data is distributed to a variety of computer systems which, under certain circumstances, are only insufficiently protected against external attacks.

It could therefore be helpful to improve protection against un-authorized access to in particular confidential data within a computer network infrastructure by technical measures and nevertheless ensure a satisfactory high-availability or disaster capability of the computer network infrastructure.

### SUMMARY

I provide a method of forwarding data between secured computer systems in a computer network infrastructure, comprising transmitting data packets along a predetermined communication path structure from a source computer system to at least one target computer system by a group of broker computer systems, wherein the communication path structure comprises a plurality of parallel sub-paths, and causing both the source computer system and the target computer system to keep predetermined network ports used for the method closed such that no connection establishment from the exterior to the source computer system or to the target computer system is permitted and thus access via a network by the network ports is prevented, wherein, the source computer system or the target computer system is capable of establishing a connection to a respective broker computer system to store data packets in the broker computer system or to fetch data packets from there.

I also provide a computer network infrastructure comprising:

a source computer system,

a target computer system, and

a group of broker computer systems,

wherein the computer systems are configured to transmit data packets along a predetermined communication path structure from the source computer system to the target computer system by the group of broker computer systems, the communication path structure comprises a plurality of parallel sub-paths, the source computer system and the target computer system each comprise an access control unit configured to keep predetermined network ports used for the method at least temporarily closed such that no connection establishment from the exterior to the source computer system or to the target computer system is permitted and thus access via a network by the network ports is prevented, and the source computer system or the target computer system is configured to establish a connection to a respective broker computer system to store data packets in the broker computer system or to fetch data packets from there.

I further provide a computer program product configured to be executed in one or multiple computer systems and which, when executed, performs the method previously described.

### BRIEF DESCRIPTION OF THE DRAWINGS

FIG. 1A is a schematic illustration of a computer network infrastructure of forwarding data between secured computer systems.

FIG. 1B is the computer network infrastructure according to FIG. 1A with diverse method steps.

FIG. 2 is a schematic illustration of a computer network infrastructure according to a further configuration of forwarding data between computer systems at different locations.

FIG. 3 is a schematic illustration of a computer network infrastructure according to a further configuration of forwarding data between computer systems at different locations.

FIG. 4 is a schematic illustration of a computer network infrastructure according to a further configuration of forwarding data between computer systems at different locations.

FIG. 5 is a schematic illustration of a computer network infrastructure according to a further configuration of forwarding data between computer systems at different locations.

### LIST OF REFERENCE NUMERALS

Computer 1 source computer system
Computer 1.1 source computer system
Computer 1.2 source computer system
Computer 2 target computer system
Computer 2.1 target computer system
Computer 2.2 target computer system
Task server 1-0 broker computer system
Task server 1-1 broker computer system
Task server 2-0 broker computer system
Task server 2-1 broker computer system
Task server 3-0 broker computer system
Task server 3-1 broker computer system
Task server 4-0 broker computer system
Task server 4-1 broker computer system
1 to 10 method steps

### DETAILED DESCRIPTION

I provide a method of forwarding data between secured computer systems in a computer network infrastructure, wherein data packets are transmitted along a predetermined communication path structure from a source computer system to at least one target computer system by a group of broker computer systems, the communication path structure comprises a plurality of parallel sub-paths, and both the source computer system and the target computer system keep predetermined network ports used for the method closed such that no connection establishment from the exterior to the source computer system or to the target computer system is permitted and thus access via network by the network ports is prevented. However, the source computer system or the target computer system may establish a connection to a respective broker computer system to store data packets in the broker computer system or fetch data packets from there.

Data packets are transmitted via various paths, namely the parallel sub-paths of the communication path structure, multiple times from the source computer system to the target computer system. This achieves a redundancy of the paths, which enables high-availability. If a sub-path or a broker computer system along a sub-path fails, data transmission to the target computer system can be maintained in the other sub-paths and computer systems. This way, the target computer system or the computer network infrastructure remains available in the functionality thereof. This achieves high-availability.

Nevertheless, the method enables high security against manipulation against the background of data security of the data packets distributed in the communication path structure because both source and target computer system are encapsulated and secured. Access to these computer systems via a network is not possible or possible only in a significantly more complicated manner at least under certain operation conditions (advantageous permanently while performing the method described herein or the above method steps).

“Predetermined network ports” means that all or only selected security relevant network ports, e.g. network ports used for the method, are permanently or temporarily closed both in the source and the target computer system.

This provides the advantage that programs need not be configured or required neither on the source nor the target computer system, which listen to the corresponding network ports from outside for the purpose of addressability or connection establishment (so-called “listening”) and form a potential security gap (for example, by a buffer overflow). Thus, “closed network ports” in this context means that these are not “listening ports”, i.e. a connection establishment from the exterior is not permitted. In this case, a third party is not capable of externally authenticating or logging-in to the source computer system or the target computer system via network, e.g. in UNIX based systems via a secure shell (SSH) daemon, or by performing specific actions on the source or target computer system.

However, local access to the source computer system may be configured for a first user group (e.g. for security personnel). Local access to the target computer system may be configured for a second user group (e.g. for an end user group or a client group). Advantageously, local access of the respective user group to the respective other computer system is prevented.

In contrast to the source and target computer system, however, the method permits external access to a broker computer system of the group pf broker computer system. Each of the group of the broker computer systems is accessible as an “open” system with at least one addressable open (“listening”) network port via network. This means that programs run and/or applications are prepared on a broker computer system so that the source computer system, the target computer system or another broker computer system are capable of accessing a respective broker computer system and establishing a connection to the broker computer system in order to store data packets in a broker computer system or fetch it from there according to the method (via an “established” connection then). In terms of security aspects, such an “open” broker computer system is to be evaluated just like a traditional specifically secured computer system.

Thus, each broker computer system serves as a (secured, but addressable) broker for a communication between the source computer system and the target computer system which however are encapsulated per se.

Data packets can be signed with at least one private key in the source computer system and possibly be encrypted (at least partially) with a public key of the target computer system. Keys or passphrases for encryption or decryption are used in a decentral fashion and can be exclusively used locally in the source and target computer system. The latter computer systems, in which data is finally processed, are protected against attacks by (permanently) closed network ports. This way, increased security of confidential data in the computer network infrastructure is ensured along with high-availability communication.

Advantageously, a data packet is transmitted from the source computer system to at least two different broker computer systems. This achieves redundancy already at the start of forwarding data at the source computer system, wherein, in a failure of an involved broker computer system, a data packet can be further transmitted from the source computer system by at least one other broker computer system in the communication path structure.

Preferably, a data packet is transmitted after reception by a broker computer system to a plurality of computer systems downstream in the communication path structure.

The following computer systems can be a broker or target computer system. This way, a data packet can be further distributed from a single computer system to a plurality of receiving computer systems, whereby a 1:n distribution is realized. The mentioned measures are also possible as being interactive so that a cascaded further distribution is effected, i.e. from one of a plurality of the receivers in turn to a plurality of further computer systems.

Furthermore, sending may be effected in an asynchronous manner. If a computer system cannot be reached, a data packet is nevertheless transmitted to the other computer systems. Further, besides different reception computer systems, even different transmission methods can be used (e.g. by the UNIX-based commands scp, rsync, transmission protocols specifically generated to that end or the like).

By a further distribution of data packets to a plurality of receiving computer systems according to an 1:n transmission, so-called “entangled” paths between individual broker computer systems within the communication path structure are possible. Entangled paths are realized in the communication path structure, for example, in that a first broker computer system transmits a data packet to a second broker computer system and the first broker computer system per se receives the data packet at the same time from this second broker computer system. This way, a first sub-path from the first broker computer system to the second broker computer system and a second sub-path from the second broker computer system to the first broker computer system result.

Alternatively, or in addition, entangled paths may be realized in that a data packet is transmitted from a plurality of broker computer systems parallel to a plurality of receiving broker computer systems. A receiving broker computer system receives a data packet in a redundant fashion via multiple sub-paths from multiple transmitting broker computer systems.

The big advantage of entangled paths in the above sense is that individual broker computer systems can be re-involved in the communication despite a failure of a sub-path located upstream in the communication because the broker computer systems receive data redundantly from another broker computer system in a parallel sub-path, quasi as bypass. Thus, a failure in a sub-path has an impact no further than the next functional broker computer system of this sub-path.

In this way, the risk of a failure, in which a sub-path of the communication path structure completely fails in the forwarding of data packets, can be significantly reduced, and, at the same time, high-availability of a target computer system within the computer network infrastructure can be significantly increased.

Due to the communication path structure with parallel redundant sub-paths, a desired redundant transmission of data packets multiple times via various paths to the same target results. This means that data packets arrive at the target multiple times (replicated).

One solution for the handling of such data packets would be to discard redundantly transmitted data packets in a corresponding target.

However, other advantageous measures result for a measure of the described type when performing the following steps:

verifying whether a predetermined data packet has already been transmitted to a broker computer system or the target computer system or is being transmitted to there, and

initiating a transmission of the data packet to the corresponding computer system if the above verification step proves that the data packet has not yet been transmitted to the corresponding computer system or is not yet being transmitted to it.

Due to these measures, the transmitted amount of data can be reduced within the communication path structure. Because data that has already been or will be transmitted needs not necessarily be transmitted once again. Thus, the computer network structure according to the method generally provides redundancy so that high-availability is ensured. An actual transmission of data packets needs not be re-effected redundantly when the corresponding data packet has already arrived at the corresponding target computer system or a corresponding receiving broker computer system. This way, the amount of data in the method is reduced.

A verification whether a predetermined data packet has already been transmitted to a broker computer system or to the target computer system or is being transmitted there, can be performed such that a broker computer system that intends to transmit a data packet, initiates a process in the receiving computer system, which provides feedback to the requesting broker computer system whether a data packet is present in the target or not. The broker computer system intending to send can decide whether it shall actually send or not based upon this feedback.

Preferably, in the method of verifying whether a predetermined data packet has already been transmitted to the corresponding computer system or is being transmitted there, a predetermined or random time period is awaited.

A computer system intending to send a data packet to a target can wait for a first time period to verify thereafter whether another redundant computer system transmits the corresponding data packet already. If no, the waiting computer system can transmit per se. If yes, a second time period is waited for by the waiting computer system until the transmission of the other computer system has been completed. Thereafter, the waiting computer system verifies whether the “foreign transmission” was successful. If yes, no further measures will be performed. If no, the waiting computer system transmits per se.

Advantageously, the transmission of data packets within the communication path structure can be effected along different network paths logically separated from one another. This not only achieves a redundancy and therefore high-availability of the broker computer systems involved in the communication, but also a potential failure of entire network paths is accounted for. Because a redundancy of broker computer systems alone is not helpful when these computer systems communicate in a single network. When the entire network fails, the entire communication disposed downward is cut-off, as a result.

By configuring a transmission along logically separated network paths, a disaster capability is realized besides high-availability because data packets can be further transmitted and processed along another network path if a network fails or, if applicable, a certain state of a computer system at a location connected via a functioning network path, can be re-established.

Advantageously, in this context, in a method of the type described, transmission of data packets to at least two target computer systems is effected at different locations. In this way, a disaster solution is realized (disaster recovery).

Advantageously, another processing of the data packets in the target computer system is effected at a second location, when a predetermined condition on the target computer system is true at the first location. A predetermined condition may, for example, be a serious problem in the target computer system at the first location or a total failure of the target computer system at the first location or a failure in the communication path toward the first location. Data in the target computer system may, for example, be switched “live”, i.e. be processed in an active process when such a condition is true in the target computer system at the first location.

As explained above, in this way a disaster capability or resolving a disaster case is realized by the method besides a redundancy of the transport of data packets toward a target computer system. This enables a redundancy of the executing target computer systems so that a failure of a target computer system at one location can be compensated in that the functionality is assumed by a second target computer system at a second location.

Preferably, the following steps are performed in the target computer system and/or in the group of broker computer systems:

retrieving routing information stored in a data packet, wherein the routing information define the predetermined communication path structure between the source computer system, the group of the broker computer systems and the target computer system within the computer network infrastructure, and

executing the transmission to computer systems downstream in the communication path structure depending on the retrieved routing information.

The routing information defines the communication path structure with its parallel sub-paths between the source computer system, the broker computer system and the target computer system. This way, the communication path structure is fixedly predetermined, wherein the involved computer systems according to the method are subject to a fixedly predetermined scope of the transmission of data packets.

Advantageously, the routing information is predefined in the data packet. For example, this may be effected in the source computer system (by a user of the source computer system) or independently thereof in a remote computer system (for example, in a so-called key computer system by an independent security responsible).

Preferably, in the method of the type described, a data packet is provided with an identifier in at least one computer system involved along the communication path structure or a an existing identifier is supplemented.

A corresponding identifier of the data packet enables tracing the packet even across multiple entities of the communication path structure (so-called “tracing”). A supplementation of the identifier may include providing a supplement to an original identifier. An original identifier of a first entity is advantageously supplemented such that the original information remains present in a form differentiable from the supplement, which is why the identifier can be traced back to its origin in an unambiguous manner even across multiple entities.

Advantageously, in the method, the route of the data packets along the various sub-paths of the communication path structure is monitored by a monitoring and/or a residence time of the data packets is monitored on an involved computer system along the communication path structure and/or all method steps are logged by the monitoring.

By the identifier of the data packets in conjunction with the stored routing information, I can determine whether a corresponding communication path is adhered to and wherein computer systems can and may be (successfully) reached. A residence time of the data packets on a predetermined computer system may be defined by the source computer system, for example, or be originally stored in a data packet by another entity (e.g. a key computer system not specified in greater detail). Furthermore, after lapse of the residence time, the data packets must not be transported further or be unfeasible, if applicable. As the case may be, alerts can be generated or other measures may be taken, which are logged by the monitoring.

Preferably, the transmission of the data packets from one of the group of the broker computer systems to the target computer system comprises:

sending a predetermined data sequence from the broker computer system to the target computer system, wherein the predetermined network ports of the target computer system are closed and the data sequence addresses one or multiple network ports of the target computer system in a predetermined order,

verifying the sent data sequence with a predetermined sequence in the target computer system, and

initiating transmission of the data packets by the target computer system if the verification of the sent data sequence is positive.

The additional method steps indicated here provide the advantage that, as a rule, the network ports (relevant for the method) of the target computer system are closed—in the sense above—and block a connection establishment from the exterior to the target computer system or significantly complicate manipulative access. Causing transmission of the data packets by the target computer system may be an automated process for the transmission of the respective data packets to the target computer system (e.g. via the UNIX-based command “Secure Copy”, scp). According to the process, the target computer system per se establishes a connection to the broker computer system and fetches the data packets. This process can be started after a predetermined data sequence was sent to the target computer system, if this sequence matches a predetermined sequence. The IP address of the sequence sending computer system can be predefined to be static in the target computer system or be taken dynamically from the source IP addresses of potential sequence sending computer systems known to the kernel of the target computer system.

Such a method is known as “port-knocking”. The above-mentioned steps can be performed by a so-called knock daemon, i.e. a program that enables port-knocking. The knock daemon is located at the network ports of the target computer system, verifies the data sequence sent to the target computer system and possibly causes a controlled transmission of the corresponding data packets from a broker computer system to the target computer system (e.g. by starting a script/program), when the sent sequence matches a predefined sequence. The course described above thus allows transmitting/copying the data packets from a broker computer system to the target computer system without that the target computer system needs to provide an open port with an addressable program.

As an alternative or in addition to the above-described port-knocking, it is also possible that the target computer system per se requests (polls) at the broker computer system at regular intervals whether one or multiple task files to be exchanged are present. In this case, a corresponding transmission of the data packets from the broker computer system to the target computer system can be initiated. It is also possible that the target computer system performs a polling when, e.g., a certain time period, in which port-knocking was not performed, is exceeded. Problems in the port-knocking can be determined in this way and functionality is maintained.

The measures described enable communication between secured computer systems (source and target computer system) within the computer network infrastructure via the group of the broker computer systems.

I also provide a computer network infrastructure comprising:

a source computer system,

a target computer system, and

a group of broker computer systems, wherein the computer systems are configured to transmit data packets along a predetermined communication path structure from the source computer system to the target computer system by the broker computer systems, the communication path structure comprises a plurality of parallel sub-paths, and the source computer system and the target computer system each comprise one access control unit configured to keep predetermined network ports used for this method closed such that a connection establishment from the exterior to the source computer system or to the target computer system via a network by the network ports is prevented, and the source computer system or the target computer system is configured to establish a connection to a respective broker computer system to store data packets in the broker computer system or to fetch them from there.

Advantageously, the computer network infrastructure is configured to perform a method as described above.

All advantages, features and measures of the above described method correspond to structural features of the computer network infrastructure and are applied in analogy. Vice versa, all structural features of the computer network infrastructure can be applied to a method of the type described above.

I further provide a computer program product configured to be executed on one or multiple computer systems and which, when executed, performs a method of the type described above.

Further advantages and examples are disclosed in the following description of the figures.

My methods, infrastructure and products will be explained in greater detail in conjunction with the drawings.

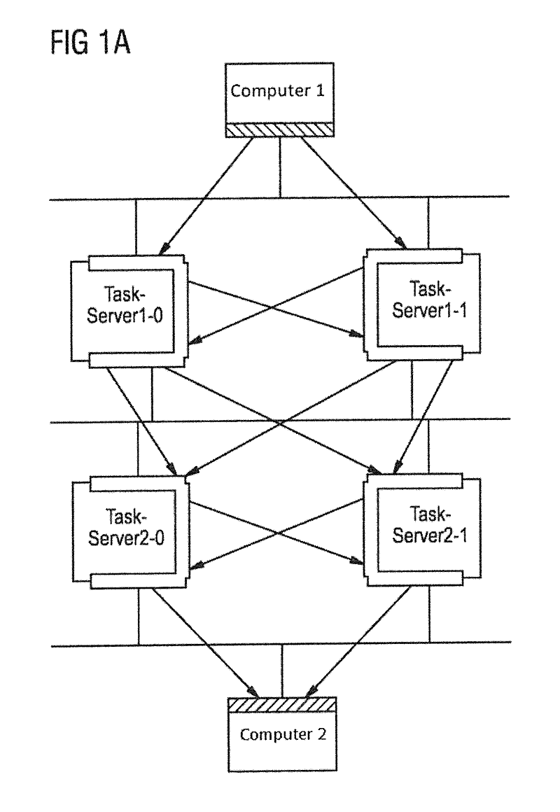

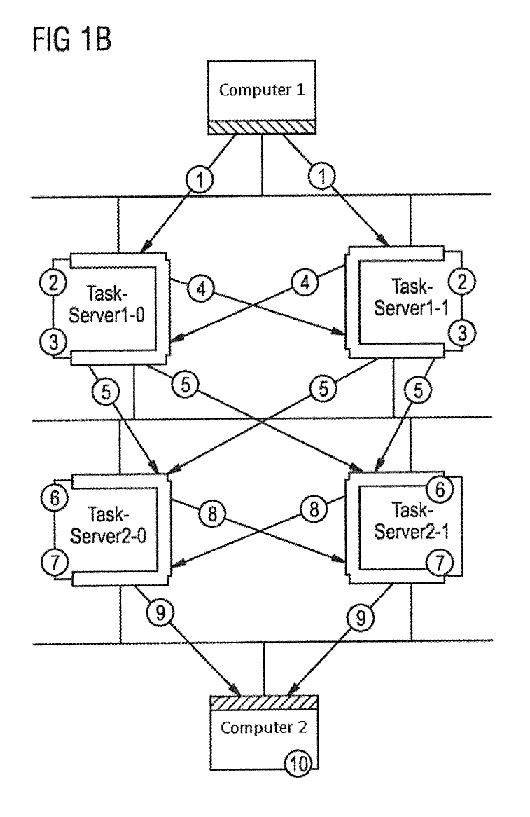

FIG. 1A shows a schematic illustration of a computer network infrastructure configured to perform a method of forwarding data between secured computer systems.

The computer network infrastructure comprises a computer 1 as a source computer system and a computer 2 as a target computer system. Data packets can be transmitted from computer 1 to the computer 2 along a group of broker computer systems, in FIG. 1A referred to as task server 1-0 to task server 2-1. Transmission of the data packets is effected along a predefined communication path structure, which is illustrated in FIG. 1A by a plurality of arrows between individual computer systems. For the technical realization of this communication path structure, all computers connect to one another via network paths.

The communication path structure comprises a plurality of parallel sub-paths so that data packets are redundantly transmitted to involved computer systems between computer 1 and computer 2. This means that a broker computer system from the group of task servers 1-0 to 2-1 is capable of receiving data packets via multiple parallel sub-paths.

In a failure of at least one of the broker computer systems task server 1-0 to 2-1 and/or a network connection between involved computer systems, the transmission of data packets can be maintained via other broker computer systems on other sub-paths of the communication path structure. This ensures high-availability of the entire computer network infrastructure, in particular a forwarding of data packets between computer 1 and computer 2.

FIG. 1A shows a so-called entangled communication path structure. This means that data packets can be exchanged between a plurality of computer systems on a level of the communication path structure (e.g. between task server 1-0 and task server 1-1) as well as be handed over to a plurality of computer systems downstream in the communication path structure (e.g. from task server 1-0 or task server 1-1, respectively, to task server 2-0 and task server 2-1, respectively).

Such a structure provides the advantage that the computer system following downstream in the communication path structure can be involved in the further communication via another sub-path of the communication path structure in the case that a network connection or a computer systems fails.

When, for example, the connection from computer 1 to task server 1-1 is not available, task server 1-1 will be involved in the communication by task server 1-0 because task server 1-0 is capable of and possibly will be transmitting a received data packet also to task server 1-1 besides the further involved task servers 2-0 and 2-1.

If, for example, there is an additional failure of the connection from task server 1-0 to task server 2-0, the task server 1-1, which is involved in the communication despite the failure of the connection to computer 1, can nevertheless transmit a data packet to task server 2-0 so that the latter is involved in the redundant communication.

This way, the computer network infrastructure is protected from various failure scenarios and combinations of involved computer systems and/or corresponding interposed network connections.

For data security within the computer network infrastructure, computers 1 and 2 are secured computer systems, which have at least all network ports involved in the described method closed, wherein no running program is configured on such a network port for external addressability of computer 1 and computer 2 via network and thus a potential attack option of these computer systems is not provided. Thus, computer 1 and computer 2 are entirely encapsulated. This is shown in FIG. 1A by a hatched input/output level of computers 1 and 2.

In contrast, the broker computer systems task server 1-0 to 2-1 are open computer systems with at least one open (“listening”) network port for addressability via network. For example, a network connection in the computer systems may be restricted via VPN (virtual private network) or SSH (secure shell) or any other combination of such methods so that only predetermined, encrypted network connections with dedicated computer systems are permitted.

Computer 1 and computer 2 may each address one or multiple of the task server 1-0 through 2-1 via network. Communication between the computer systems is effected as follows. Computer 1 can store data packets according to FIG. 1A on the task server 1-0 and 1-1 because the latter are directly addressable via network. The data packets are distributed further along the communication path structure to the further task servers 2-0 and 2-1 in a redundant fashion.

For the transmission of data packets to the computer 2, the task servers 2-0 or 2-1 each perform port-knocking toward computer 2. To that end, a predetermined data sequence is transmitted from the respective task server 2-0 or 2-1 to computer 2, wherein computer 2 keeps at least all network ports involved in these transfers closed. A knock daemon at the network ports of the computer 2 matches the sent data sequence with a predefined sequence in computer 2.

If the verification of the sent data sequence is positive, computer 2 initiates establishing a connection to the respective task server 2-0 or 2-1 and transmission of the data packets from the respective task server 2-0 or 2-1. Such a transmission can be realized by the UNIX based “scp” command, for example. This way, computer 2 fetches data packets from task server 2-0 and 2-1, respectively, after a port-knocking.

FIG. 1B shows the topology according to FIG. 1A, wherein the method steps of forwarding data packets along the communication path structure are illustrated and will be explained hereinafter in greater detail.

In a step 1, a parallel transmission of a data packet from computer 1 is effected by a network connection to task server 1-0 and task server 1-1, respectively.

In step 2, a local verification is effected in task servers 1-0 or 1-1 as to whether the data packet has already arrived or not. This verification can be repeated, if required, until the data packet is received in the respective task servers 1-0 and 1-1, respectively (e.g. in an inbox provided to that end).

In a further step 3, detection of another routing of a received data packet is effected. Predetermined routing information, which define a communication path of the data packet, may be stored in the data packet to that end. In a respective task server 1-0 or 1-1, a data packet can be unpacked and the routing information for a routing to further computer systems (task server 1-0 or 1-1 as well as 2-0 and 2-1) can be read.

In a respective step 4, tasks servers 1-0 and 1-1 verify (e.g. after waiting a random time period) whether the corresponding data packet is entirely available on the respective other computer system. To that end, task server 1-0 may send a query to task server 1-1 or vice versa, for example. If step 4 proves that the data packet is not present in one of the two systems (e.g. because a transmission from computer 1 failed), the verifying computer systems (e.g. task server 1-0 toward task server 1-1) will take actions according to the routing determined from the data packet in advance and transmits a replica of the data packet to the broker computer system in which the data packet has previously not been available (e.g. task server 1-1).

This way, task server 1-1 may be re-involved in the communication and forwarding of data packets by task server 1-0, even if a transmission of a data packet from computer 1 to task server 1-1 has failed.

In a further step 5, which may optionally be effected simultaneously or temporarily offset to step 4, task servers 1-0 and 1.1 verify toward task servers 2-0 or 2-1 whether a corresponding data packet is already available in the latter systems (e.g. because it has already been transmitted there from the respective other broker computer system task server 1-0 or task server 1-1).

For verification in this step 5, e.g. task server 1-0 may wait for a time period randomly defined within a predetermined frame before a query is directed to the receiving broker computer systems task server 2-0 or 2-1. This time period serves for awaiting whether task server 1-1 has already initiated a transmission to the task server 2-0 and/or 2-1.

If this is the case, task server 1-0 may await another time period whether a transmission from task server 1-1 to task server 2-0 or 2-1 has been successful.

In this case, a verification through task server 1-0 shows that data packets are present on task server 2-0 or 2-1 so that task server 1-0 does not need to transmit.

However, if there had been any transmission by task server 1-1 after waiting for the first time period, or if a waiting for the second time period shows that a transmission from task server 1-1 failed, task server 1-0 finally initiates a transmission of further replicas of the data packet to the task servers 2-0 and 2-1 according to a routing determined from the data packet in advance, respectively, in step 5.

Task server 1-1 performs the same actions toward to task server 1-0 as well as toward to task servers 2-0 and 2-1 as described above in the context with task server 1-0 (steps 3, 4, and 5).

Furthermore, it is also possible that a transmission from task servers 1-0 or 1-1 to task servers 2-0 or 2-1 was successful, however, not to the other one of the involved task servers. Then, a step 5 from task server 1-0 or 1-1 is advantageously only effected toward task servers 2-0 or 2-1, on which the data packet is not yet present.

This way, replicas of the data packets can redundantly be transmitted to task servers 2-0 or 2-1 by task servers 1-0 or 1-1 so that data packets are present with high-availability in the respective broker computer systems (task server 1-0 to 2-1). However, the above-described measures do not permit a reduce in the amount of data to be transmitted because data packets need no longer be transmitted since they are already present in the respective target computer system. This is effected by the above-described verification measures.

In a respective step 6, task servers 2-0 and 2-1 verify locally if they have received a data packet analogously to the measures as described above in the context of task servers 1-0 and 1-1 in step 2.

Furthermore, analogously to the method between task servers 1-0 and 1-1 (see steps 3 and 4 above), task servers 2-0 and 2-1, respectively, determine a further routing from the data packet in a step 7, and verify, in step 8, among each other if a data packet has successfully been transmitted to the respective other system and is entirely present there.

If this is not the case for one of the involved systems task server 2-0 and 2-1, respectively, the respective other system transmits a replica of the data packets to the system in which the data packet is not yet present.

In a further step 9, both task servers 2-0 and 2-1 finally verify whether data packets have already been successfully transmitted to computer 2 or not (by the respective other system).

Since computer 2 is encapsulated with network ports closed for this purpose, task servers 2-0 and 2-1, respectively, effect a port-knocking process toward computer 2, wherein the latter per se addresses the respective task servers 2-0 or 2-1 via network and communicates as to whether the data packet is already present on computer 2 or not. In the verification process between task servers 2-0 and 2-1, respectively, and the computer 2, the involved task servers 2-0 and 2-1, respectively, can also await predetermined or random time periods, as described above in the context of task servers 1-0 and 1-1. If a data packet is not yet present in computer 2, computer 2 then fetches the data packet from the respective task server 2-0 or 2-1 in step 9.

In step 10, it is finally locally verified in computer 2 if the data packet has been successfully transmitted and is entirely present on computer 2. If this is not the case, a transmission of the data packet can be re-initiated toward one of the involved task servers 2-0 or 2-1 or toward multiple of the involved task servers.

FIGS. 1A and 1B illustrate a scenario for the redundantly available forwarding of data packets between a computer 1 and a computer 2 by the involved broker computer systems task servers 1-0 to 2-1, wherein all systems connect to each other via networks.

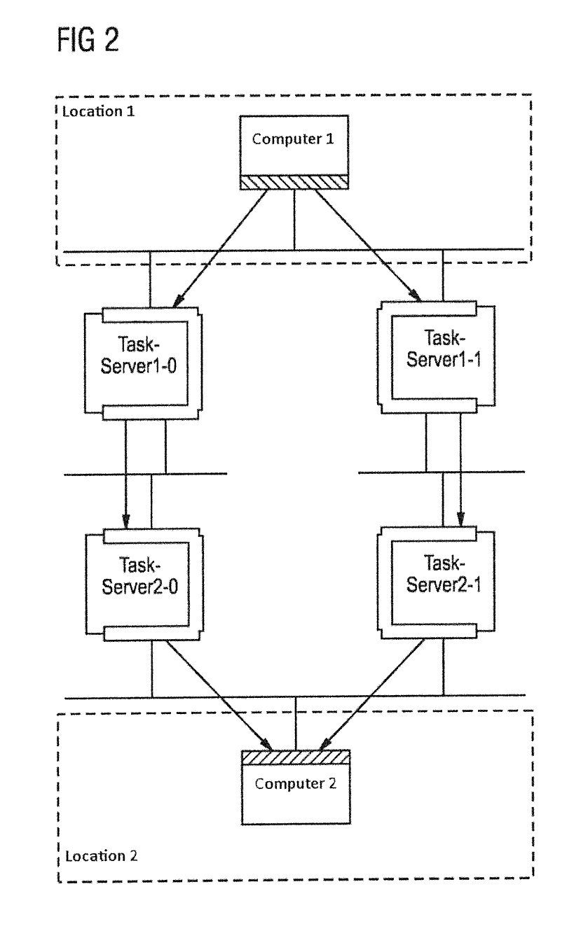

FIG. 2 shows a schematic illustration of a computer network infrastructure according to a further configuration. A computer 1 is configured at a location 1 and a computer 2 is configured at a location 2. Locations 1 and 2 may be physically (locally) and/or logically separated locations. Data packets can be transmitted from the computer to the computer 2 by a group of broker computer systems task servers 1-0 through 2-1.

In contrast to the configuration according to FIGS. 1A and 1B, the communication path structure between the computer 1 and the computer 2 according to FIG. 2 comprises two logically separated network paths. A first network path connects the computer 1 to computer 2 by the task server 1-0 as well as 2-0. A second network path connects the computer 1 to computer 2 by the task server 1-1 and 2-1. This way, a computer network infrastructure is formed which comprises redundant network paths.

The task servers 1-0 and 2-0 may be configured at a different location than the task servers 1-1 and 2-1. This way, data can redundantly be transmitted from computer 1 to computer 2 (target computer) via network paths at different locations. For example, data packets can be forwarded from a computer center (by computer 1) via different network providers (one provider for the two separate network paths) via different inter-stations (for example, task server 1-0 or 2-0 respectively at a first location and task server 1-1 or 2-1 respectively at a second location). Optionally, the respective locations can also be at one of the locations of computer 1 and computer 2, respectively. Various configurations are possible.

The configuration of FIG. 2 provides the advantage that in a failure of a network along a network path, data packets can be redundantly forwarded along the other network path.

Just like in the configuration according to FIGS. 1A and 1B, computer 1 and computer 2 are encapsulated through closed network ports according to the configuration of FIG. 2. The task servers 1-0 to 2-1, however, are externally addressable via network as open systems. Communication and forwarding of data packets between computer 1, the task servers 1-0 to 2-0 and computer 2 is effected analogously to the descriptions according to FIGS. 1A and 1B.

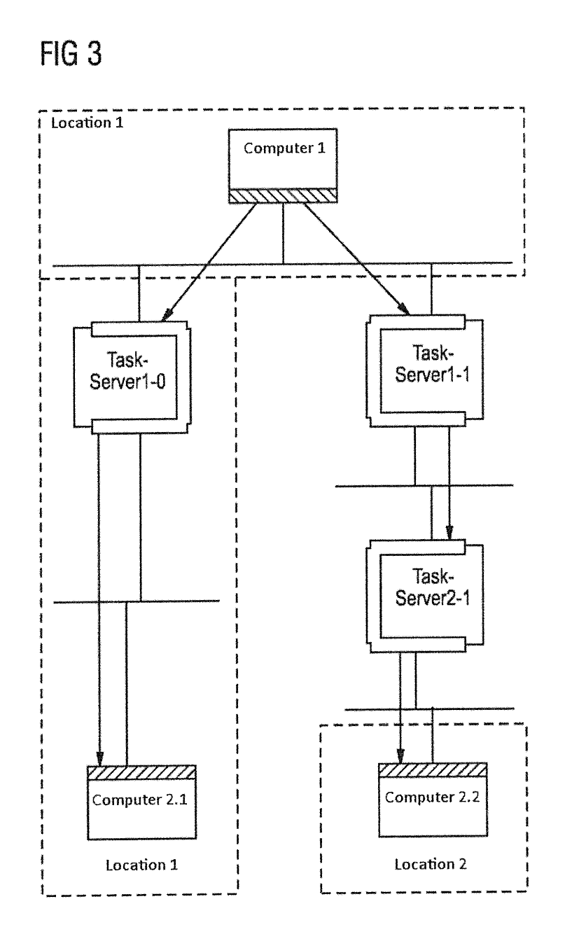

FIG. 3 shows a configuration of a computer network infrastructure to distribute data packets to different locations for the realization of a disaster concept.

The computer network infrastructure comprises a computer 1 as source computer system of data packets, as well as two target computer systems computer 2.1 and computer 2.2 for receiving forwarded data packets. The broker computer systems task server 1-0, task server 1-1 as well as task server 2-1 are configured to forward the data packets between computer 1 and the involved computers 2.1 and 2.2. According to the configuration of FIG. 3, the computers 1 and 2.1 as well as task server 1-0 are configured at a location 1. Computer 2 is configured at a location 2.

The transport of data packets between computer 1 and computer 2.1 is effected by the task server 1-0 along a first network path. The transport of data packets between computer 1 and computer 2.2 is effected by task servers 1-1 and 2-1 along a second separate network path.

Thus, data packets are transported by computer 1 at location 1 via different connections to a computer 2.1 at location 1 and additionally to a computer 2.2 at location 2. The location 2 may constitute a so-called disaster recovery location. That is, in case of serious problems of computer 2.1 at location 1, data can functionally be switched “live” at location 2. For example, in a failure of computer 2.1 at location 1, or in a defective or incomplete transmission of data packets to computer 2.1 at location 1, a functionality of the computer network infrastructure can be maintained by an activation of computer 2.2 at location 2 and/or a recovery or execution of data packets in computer 2.2 at location 2.

Thus, the configuration according to FIG. 3 allows a disaster capability of compensating a failure of a target computer system by the reception of the functionality in a further target computer system that received data packets from a source computer system on redundant network paths.

As an alternative to the configuration illustrated in FIG. 3, all kinds of variations in using task servers and encapsulated computers, which do not comprise open network ports, are possible. The number of used task servers and the localization thereof, in particular when transporting data packets from computer 1 to computer 2.2, may vary depending on the requirements. In the example according to FIG. 3, the task servers 1-1 and 2-1 may be localized at location 1 or at location 2 or possibly also be omitted.

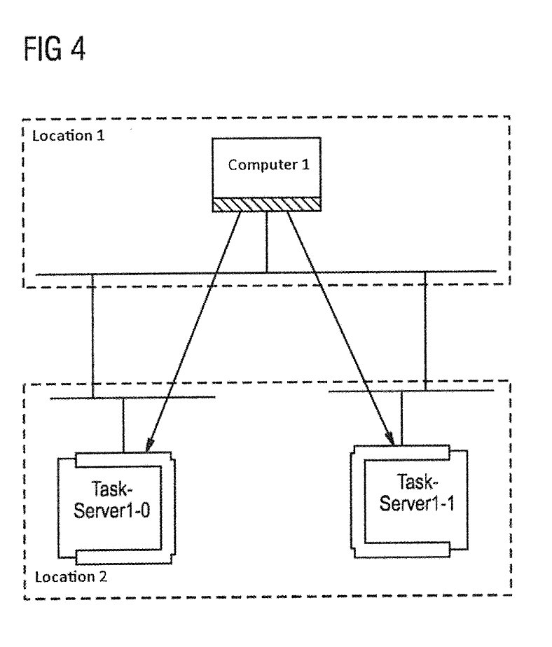

FIG. 4 shows a further configuration of a part of a computer network infrastructure with a computer 1 encapsulated (i.e. comprises no open network ports) and accommodated at a location 1. At a separate location 2, two broker computer systems task servers 1-0 and 1-1 are configured, which can be addressed by computer 1 via separate network paths. The configuration according to FIG. 4 allows a forwarding from a first location 1 to a second location 2 by separate network paths. If a network path fails, another network path is redundantly provided to forward data packets.

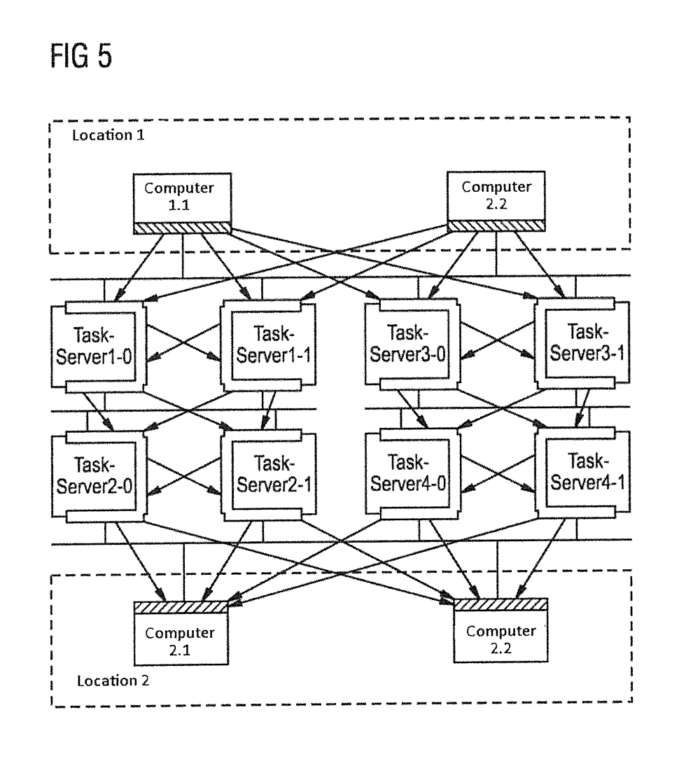

FIG. 5 shows a schematic illustration of a further configuration of a computer network infrastructure in which redundant network paths as well as redundant forwarding of data packets between different broker computer systems within a respective network path are configured.

Specifically, the computer network infrastructure according to FIG. 5 comprises two source computer systems computer 1.1 as well as computer 1.2. Furthermore, two target computer systems computer 2.1 and computer 2.2 are configured.

The source computer systems computer 1.1 and computer 1.2 are configured at a location 1. The target computer systems computer 2.1 and computer 2.2 are configured at a location 2.

A forwarding of data packets between location 1 and location 2 is effected by two groups of broker computer systems, wherein in each case one group is assigned to one network path structure.

A first group of broker computer systems is formed by the task servers 1-0 to 2-1, which can communicate with each other within a first network path.

A second group of broker computer systems is formed by the task servers 3-0 to 4-1, which can communicate with each other within a second network path.

A respective group of broker computer systems within a network path can mutually redundantly exchange data packets, as described above in FIGS. 1A and 1B. Thus, high availability is realized in each of the two groups of broker computer systems.

By at the same time redundantly providing two network paths, it is ensured that a redundant network path for forwarding data packets in a highly-available manner is configured at location 2 in a failure of a complete network path. Data packets are redundantly forwarded from the two source computer systems computer 1.1 and computer 1.2 to all from the two groups of broker computer systems task server 1-0 to task server 2-1 and task server 3-0 to 4-1, respectively, and are redundantly exchanged within the groups of broker computer systems. A forwarding to the target computer systems computer 2.1 or computer 2.2 at location 2 is redundantly effected.

Thus, the configuration according to FIG. 5 represents a combination of the configurations of FIGS. 1A and 1B in conjunction with FIG. 2 and/or FIG. 3.

Generally, all configurations, as illustrated in FIGS. 1A to 5, may be combined, varied and supplemented in terms of high availability or disaster capability respectively.

All configurations provide the advantage that high availability and disaster capability, respectively, is combined with data security by a communication method between encapsulated source or target computer systems, respectively.

1.-15. (canceled)

16. A method of forwarding data between secured computer systems in a computer network infrastructure, comprising transmitting data packets along a predetermined communication path structure from a source computer system to at least one target computer system by a group of broker computer systems, wherein the communication path structure comprises a plurality of parallel sub-paths, and causing both the source computer system and the target computer system to keep predetermined network ports used for the method closed such that no connection establishment from the exterior to the source computer system or to the target computer system is permitted and thus access via a network by the network ports is prevented, wherein, the source computer system or the target computer system is capable of establishing a connection to a respective broker computer system to store data packets in the broker computer system or to fetch data packets from there.

17. The method according to claim 16, wherein a data packet is transmitted from the source computer system directly to at least two different broker computer systems.

18. The method according to claim 16, wherein a data packet, after reception by a broker computer system, is transmitted to a plurality of computer systems downstream in the communication path structure.

19. The method according to claim 16, further comprising:
verifying whether a predetermined data packet has already been transmitted to a broker computer system or to the target computer system or is being transferred to there, and
initiating a transmission of the data packet to the corresponding computer system if the above verification step shows that the data packet has not yet been transmitted to the respective computer system or is not yet being transmitted.

20. The method according to claim 19, wherein a predetermined or random time period is used to verify whether a predetermined data packet has already been transmitted to the corresponding computer system or is being transmitted to there.

21. The method according to claim 16, wherein the transmission of the data packets within the communication path structure is effected along different, logically separated network paths.

22. The method according to claim 21, wherein transmission of the data packets within the communication path structure is effected between logically and/or physically separated locations of the involved computer systems.

23. The method according to claim 22, wherein transmission of the data packets to at least two target computer systems is effected on different locations, and a further processing of the data packets is effected in the target computer system at the second location when a predetermined condition in the target computer system at the first location is fulfilled.

24. The method according to claim 16, further comprising in the source computer system and/or in the group of broker computer systems:
retrieving routing information stored in a data packet, wherein the routing information define the predetermined communication path structure between the source computer system, the group of the broker computer systems and the target computer system within the computer network infrastructure, and
executing the transmission to computer systems downstream in the communication path structure depending on the retrieved routing information.

25. The method according to claim 16, wherein the transmission of the data packets from one of the group of broker computer systems to the target computer system comprises:
sending a predetermined data sequence from the broker computer system to the target computer system, wherein the predetermined network ports of the target computer system are closed and the data sequence addresses one or multiple network ports of the target computer system in a predetermined order,
verifying the sent data sequence with a predefined sequence in the target computer system, and
causing the transmission of the data packets by the target computer system if verification of the sent data sequence is positive.

26. The method according to claim 16, wherein each data packet is provided with an identifier unique within the computer network infrastructure in at least one computer system involved along the communication path structure or an existing identifier of the data packet is supplemented.

27. The method according to claim 26, wherein the route of the data packets along the communication path structure is monitored using the identifier by a monitoring and/or a residence time of the data packets on a computer system involved along the communication path infrastructure is monitored and/or all method steps are logged by the monitoring.

28. A computer network infrastructure comprising:
a source computer system,
a target computer system, and
a group of broker computer systems,
wherein the computer systems are configured to transmit data packets along a predetermined communication path structure from the source computer system to the target computer system by the group of broker computer systems, the communication path structure comprises a plurality of parallel sub-paths,
the source computer system and the target computer system each comprise an access control unit configured to keep predetermined network ports used for the method at least temporarily closed such that no connection establishment from the exterior to the source computer system or to the target computer system is permitted and thus access via a network by the network ports is prevented, and
the source computer system or the target computer system is configured to establish a connection to a respective broker computer system to store data packets in the broker computer system or to fetch data packets from there.

29. The computer network infrastructure according to claim 28, configured to perform a method comprising transmitting data packets along a predetermined communication path structure from a source computer system to at least one target computer system by a group of broker computer systems, wherein the communication path structure comprises a plurality of parallel sub-paths, and causing both the source computer system and the target computer system to keep predetermined network ports used for the method closed such that no connection establishment from the exterior to the source computer system or to the target computer system is permitted and thus access via a network by the network ports is prevented, wherein, the source computer system or the target computer system is capable of establishing a connection to a respective broker computer system to store data packets in the broker computer system or to fetch data packets from there.

30. A computer program product configured to be executed in one or multiple computer systems and which, when executed, performs the method according to claim 16.
